(19) United States
(12) Patent Application Publication
(10) Pub. No.: US 2003/0157279 A1
(43) Pub. Date: Aug. 21, 2003

(54) Container ID Tag

(76) Inventor: George E. Rudish, Sterling Heights, MI (US)

Correspondence Address: Gregory T. Zalecki, Suite 415, 12900 Hall Rd., Sterling Heights, MI, 48313, US

(21) Appl. No.: 10/079,002

(22) Filed: Feb. 20, 2002

(51) Int. Cl. B32B 1/02

(52) U.S. Cl. 428/34.1; 428/40.1

(57) ABSTRACT

A container ID tag is disclosed. The container ID tag is intended for use on any container. Its preferred use is upon beverage containers. The container ID tag is comprised of a tag, an adhesive and a scratchable opaque coating. The tag is a strip of material, preferably paper or cardboard. The adhesive is applied to one side of the tag. It is used to secure the tag to the container. An optional nonstick peelable backing is attached to the adhesive to enhance handling. A scratchable opaque coating is applied to the other side of the tag. Preferably, the coating is a waxy opaque material. The coating is scratchable. The scratchable characteristic of the coating permits its removal by scratching with a writing implement such as a coin, fingernail, nail or paperclip. The tag and coating are of contrasting colors. This permits inscriptions to be made upon the ID tag by removing the coating with a writing implement. To use the ID tag, the nonstick peelable backing is removed and the tag is affixed to a container. Identifying inscriptions may then be made upon the ID tag. Other versions of the invention include tagged containers which have the ID tag attached at the time of distribution and methods for identifying containers. The adhesive may be pre applied to the container and removed as a component part of the ID tag itself.

### BACKGROUND

People often gather together and consume beverages. There may be only a few people gathered together, such as at a family dinner. Or, there may be many people gathered together, such as at a large party. Whenever a group of people gather together and consume beverages, their beverage containers may become mixed up. For example, a person may leave his beverage container in the presence of others while he uses the restroom. Upon returning he may be unable to identify his beverage container.

In situations such as this it becomes possible for beverage containers to become mixed up. One person may end up drinking from another's container. Drinking from a beverage container previously used by another is offensive to many people. Also, drinking from a beverage container previously used by another may result in the transmission of disease from the first user to the second user. Mixups can occur after partially consumed beverages are stored in a refrigerator. The original beverage owner, after the lapse of some time, may be unable to identify the beverage which he placed within the refrigerator. Some respond to these mixups by discarding their partially consumed beverages. Others respond by consuming beverages which may have been previously partially consumed by others, thereby subjecting themselves to the risk of disease transmission.

One method to solve the mixup problem is to attach an identifying writing to the beverage container. First, a writable material with an adhesive backing, such as masking tape, must be located. This writable material is then cut to size and attached to the container. Lastly, an identifying inscription is inscribed on the writable material in order to uniquely identify the container. Before such an inscription maybe made upon the writable material a writing implement, such as a pencil or a pen, must be located. The problem with this approach is that time and effort are needed to locate the writable material, cut it to size, attach it to the container, locate the writing implement and inscribe an inscription on the writable material.

The problem of easily identifying containers does not only apply to beverage containers. Other containers, such as parts containers, must also be uniquely identified under many circumstances. For example, it may be desirable to identify a box of screws by the screw size.

There is a need for a container ID tag for quickly and easily identifying containers, including beverage containers.

### SUMMARY

The present invention is directed to an ID tag and methods for identifying containers that satisfies this need. The device comprises a tag, an adhesive and a scratchable opaque coating. The tag is a strip of material, such as paper. The adhesive is applied to one side of the tag. It is used to secure the tag to the container. A scratchable opaque coating is applied to the other side of the tag. This may be a waxy opaque material such as is commonly used on instant lottery tickets. The scratchable feature of the coating permits removal of the coating by scratching it with a coin, fingernail, nail, paperclip or any other object of choice which is capable of removing the coating. The opaqueness feature of the coating causes the underlying tag to be not visible unless parts of the coating are removed by scratching. The tag and coating are of contrasting colors. Thus identifying inscriptions may be made on the container ID tag by scratching the coating off of the tag.

### DRAWINGS

These and other features, aspects, and advantages of the present invention will become better understood with regard to the following description, appended claims, and accompanying drawings where:

FIG. 1 is a plan view of the preferred embodiment of a container ID tag.

FIG. 2 is a cross-sectional view at line 2-2 of the container ID tag of FIG. 1.

FIG. 3 is a perspective view of the container ID tag of FIG. 1 being applied to a container.

FIG. 4 is a perspective view of the container ID tag of FIG. 1 being applied to a container, further showing the removal of a nonstick peelable backing affixed to the adhesive of the container ID tag.

FIG. 5 is a perspective view of another version of a container ID tag affixed to a container, the container having pre applied adhesive.

FIG. 6 is a perspective view showing the making of a manual inscription upon the container ID tag of FIG. 1 after the container ID tag is affixed to a container.

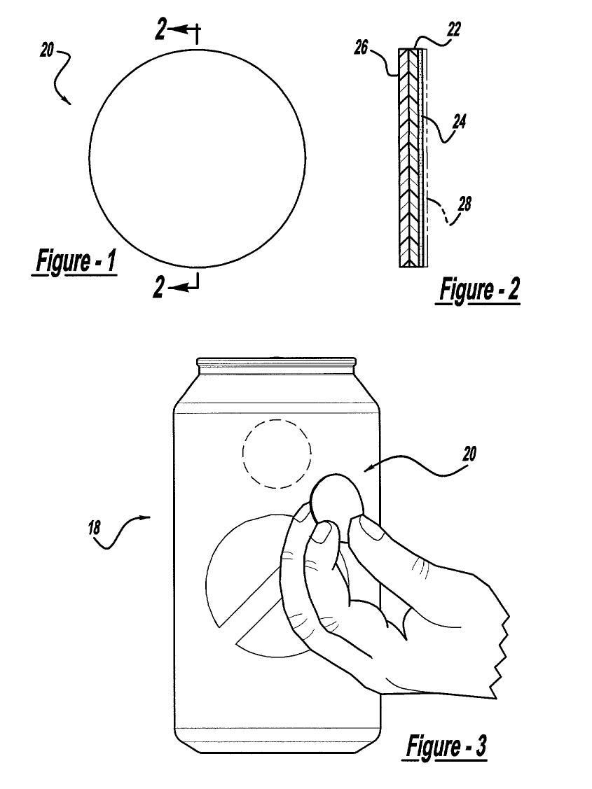

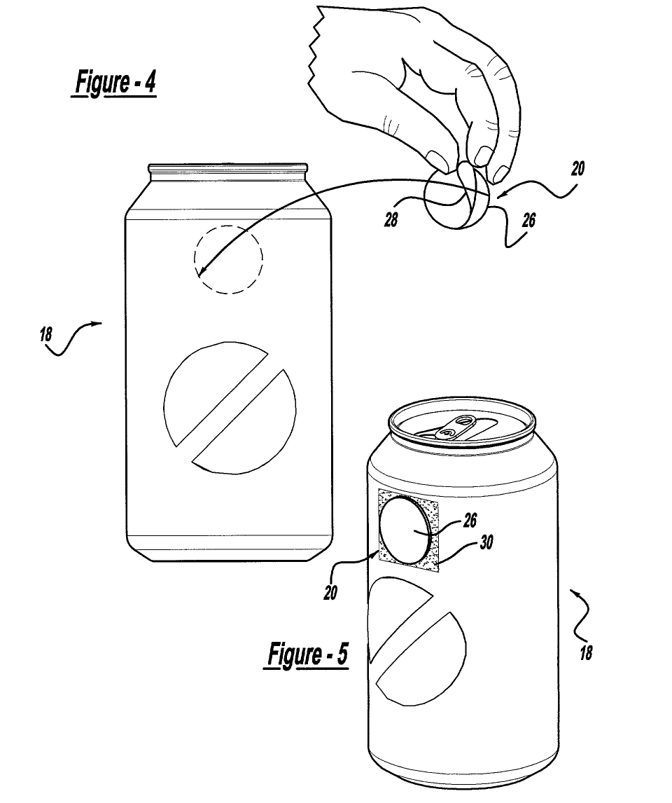

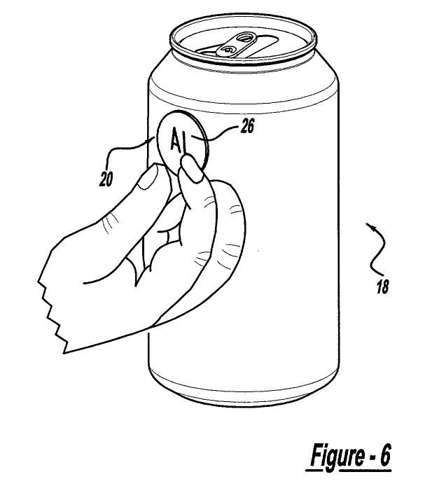

### DESCRIPTION

The preferred version of this invention is a container ID tag 20 for identifying a container 18, the container ID tag being comprised of a tag 22, an adhesive 24, a scratchable opaque coating 26 and a nonstick peelable backing 28. The nonstick peelable backing 28 is an optional component.

Preferably, the tag 22 is constructed from paper or cardboard. It is sized and shaped to fit on the container 18. The color of the tag 22 must contrast with the color of the scratchable opaque coating 26. The contrasting colors allow messages or other inscriptions to be visible when the scratchable opaque coating 26 has an inscribed message removed from it by scratching.

The adhesive 24 is applied to one side of the tag 22. The adhesive 24 must be capable of securing the tag 22 to the container 18. Preferably, the adhesive 24 is water resistant. This will inhibit the tendency of container ID tags 20 to fall off of cold containers 18 which have condensation on them.

The scratchable opaque coating 26 is applied to the other side of the tag 22. The coating 26 has a color which contrasts with the color of the tag 22. The opaqueness of the coating 26 renders the tag 22 not visible unless some of the coating 26 is removed. The coating 26 is scratchable. The scratchable opaque coating may be removed by scratching it with a tool capable of making inscriptions. Such tools include coins, fingernails, nails, paperclips and any other object which is capable of removing the coating. Messages and identifying insignia may be placed upon the container ID tag 20 by removing some of the scratchable opaque coating 26 in such a manner that visible inscriptions remain. An inscription may be made by scratching off some of the coating 26 with a fingernail, a coin or a paperclip. The making of such an inscription upon a container ID tag 20, which has been placed upon a container 18, allows the container 18 to be uniquely identified.

Preferably, the scratchable opaque coating 26 is an opaque wax. Any material similar to the scratchable opaque coatings commonly used on instant lottery cards or other “instant win” chance game pieces may be used as the scratchable opaque coating 26. Such materials are often used on game pieces distributed by fast food restaurants. The common feature of the scratchable opaque coatings 26 is that they are capable of leaving written impressions uncovered on the tag when the coating is removed by scratching.

The nonstick peelable backing 28 is attached to and covers the adhesive 24. The backing 28 may be constructed from paper or cardboard. When the backing 28 is attached to the adhesive the container ID tag 20 may be easily handled without having it stick to the user's hands or other objects. The use of the nonstick peelable backing 28 as a component of a container ID tag 20 is optional. If the nonstick peelable backing 28 is not used, the container ID tag 20 will have a lower manufacturing cost, but it will be more difficult to handle because of the tendency of the adhesive 24 to stick to anything with which it comes into contact.

The container ID tag 20 is used by affixing it to a container 18. The adhesive 24 permits the container ID tag 20 to be affixed to the container 18. A message, or other identifying insignia, is then placed upon the container ID tag 20 by removing some of the scratchable opaque coating 26. The scratchable opaque coating 26 is preferably removed by scratching with a fingernail, coin or paperclip. Such scratching may be used to write a person's name, telephone number or other message upon the container ID tag 20.

The container ID tag 20 is ideal for identifying handheld beverage containers. Such containers include beer, pop, juice and water cans and bottles. The use of the container ID tag 20 inhibits the mixing up of one person's beverage container with the beverage container of another person.

One version of this invention is a tagged container comprising a container 18 and a container ID tag 20 affixed to the container. A container ID tag 20, as described above, may be used in this configuration. In the alternative, a two-part container ID tag 20 may be used in conjunction with a container 18 which has pre applied adhesive for affixing the container to a container ID tag 20 pre applied to the container. If adhesive is pre applied to the container 18, as shown in FIG. 5, it is not necessary to have an adhesive layer 24 on the container ID tag 20. The container ID tag 20 would then be comprised of the tag 22 and the scratchable opaque coating 26. This would reduce the cost of mass producing tagged containers which have container ID tags 20 applied to the tagged containers before distribution.

Another version of this invention is a method for identifying containers. The method involves the following steps. First, a container ID tag 20 is selected. Next, the container ID tag 20 is affixed to a container 18. Finally, the container 18 is identified by inscribing the container ID tag 20 with an inscription. This method may also be used with a two-part ID tag 20. Such an ID tag 20 is comprised of a tag 22 and a scratchable opaque coating 26, of a color contrasting to the tag, capable of leaving written impressions uncovered on the tag when the coating is removed by scratching, applied to one side of the tag. Whenever a two-part ID tag 20 is used, adhesive must be pre applied to the container 18. In both configurations the adhesive serves the purpose of affixing the ID tag 20 to the container 18.

What is claimed is:

1. A container ID tag comprising:
(a) a tag;
(b) an adhesive, capable of securing the tag to a container, applied to one side of the tag; and
(c) a scratchable opaque coating, of a color contrasting to the tag, capable of leaving written impressions uncovered on the tag when the coating is removed by scratching, applied to the other side of tag.

2. A method for identifying containers comprising:
(a) selecting a container ID tag comprising:
(i) a tag;
(ii) an adhesive, capable of securing the tag to a container, applied to one side of the tag; and
(iii) a scratchable opaque coating, of a color contrasting to the tag, capable of leaving written impressions uncovered on the tag when the coating is removed by scratching, applied to the other side of tag;
(b) Affixing the container ID tag to a container; and
(c) Inscribing the container ID tag with an identifying inscription.

3. A method for identifying containers comprising:
(a) selecting a container ID tag comprising:
(i) a tag; and
(ii) a scratchable opaque coating, of a color contrasting to the tag, capable of leaving written impressions uncovered on the tag when the coating is removed by scratching, applied to the other side of tag;
(b) Affixing the container ID tag to a container having pre applied adhesive for affixing a container ID tag to the container; and
(c) Inscribing the container ID tag with an identifying inscription.

4. A tagged container comprising:
(a) a container;
(b) a container ID tag affixed to the container, the container ID tag comprising:
(i) a tag;
(ii) an adhesive, capable of securing the tag to a container, applied to one side of the tag; and
(iii) a scratchable opaque coating, of a color contrasting to the tag, capable of leaving written impressions uncovered on the tag when the coating is removed by scratching, applied to the other side of tag.

5. A tagged container comprising:
(a) a container having pre applied adhesive for affixing a container ID tag to the container; and
(b) a container ID tag affixed to the container with the pre applied adhesive, the container ID tag comprising:
(i) a tag; and
(ii) a scratchable opaque coating, of a color contrasting to the tag, capable of leaving written impressions uncovered on the tag when the coating is removed by scratching, applied to the other side of tag.

6. The container ID tag recited in claim 1, further comprising a nonstick peelable backing affixed to the adhesive.

7. The method for identifying containers recited in claim 2, wherein the container is a handheld beverage container.

8. The tagged container as recited in claim 4, wherein the container is a handheld beverage container.

9. The tagged container as recited in claim 5, wherein the container is a handheld beverage container.
